(19) United States
(12) Patent Application Publication
(10) Pub. No.: US 2004/0128689 A1
(43) Pub. Date: Jul. 1, 2004

(54) Method and system for enabling channel set up in a television signal receiver

(76) Inventors: Michael Anthony Pugel, Noblesville, IN (US); Max Ward Muterspaugh, Indianapolis, IN (US)

Correspondence Address: Joseph S Tripoli, Thomson Multimedia Licensing Inc, PO Box 5312, Princeton, NJ, 08543-5312, US

(21) Appl. No.: 10/297,353

(22) PCT Filed: Jun. 5, 2001
(86) PCT No.: PCT/US01/18147

(51) Int. Cl. H04N 7/20; H04N 5/50; G06F 13/00; H04N 5/445

(52) U.S. Cl. 725/72; 348/731; 725/39

(57) ABSTRACT

A method and system for enabling channel set up and antenna control in a television signal receiver provides an efficient way in which to optimize channel tuning. According to an exemplary embodiment, a television signal receiver such as a digital television (DTV) receiver includes a memory for receiving and storing data provided from a storage medium. The data includes a channel list having one or more channels available for reception by the television signal receiver at a designated location and antenna control information corresponding to each of the channels in the channel list. According to an exemplary embodiment, the storage medium is a database which provides the channel list and antenna control information to the television signal receiver over a communications network such as the internet.

The present invention generally relates to facilitating a set up process in a device such as a television signal receiver, and more particularly, to a method and system for providing such a device with information regarding available channels at a given location and enabling antenna control. The advent of digital television (“DTV”) provides users with improved image quality as compared to conventional signal formats. However, it also presents a new challenge to the reception capability of a television signal receiver or set top box receiver. The DTV system has been particularly sensitive to problems in signal reception. These problems may require more elaborate solutions is than simply connecting a conventional antenna such as rabbit ears to the receiver.

One advancement being proposed involves a controllable antenna. Such an antenna is capable of pointing in a particular direction to promote improved signal reception and help remove undesired artifacts, such as ghosts or interference elements. Operating such an antenna, however, even to receive just a few broadcast channels can be quite troublesome and time consuming for a user. This problem can be particularly overwhelming for users in certain locations where many channels are available. Conventional auto-scan search features employed in many analog television systems offer little relief since they may not be capable of detecting all of the available DTV channels. Accordingly, there is a need for an improved technique for assisting users in setting up their television systems and achieving good channel reception.

The present invention enables channel set up and antenna control in a television signal receiver to optimize channel tuning. According to an exemplary embodiment, a television signal receiver such as a DTV receiver includes a memory for receiving and storing data provided from a storage medium. The data includes a channel list having one or more channels available for reception by the television signal receiver at a designated location and antenna control information corresponding to each of the one or more channels in the channel list. According to an embodiment, the storage medium is a database, and the channel list and antenna control information are downloaded from the database to the memory of the television signal receiver via the internet. According to another embodiment, the storage medium is a CD-ROM or other similar data storage device. The storage medium is preferably updated periodically to provide current channel information and current antenna control information. The channel information and the corresponding antenna control information are used to assist users in setting up their television systems and achieving proper channel tuning.

The above-mentioned and other features and advantages of this invention, and the manner of attaining them, will become more apparent and the invention will be better understood by reference to the following description of embodiments of the invention taken in conjunction with the accompanying drawings, wherein:

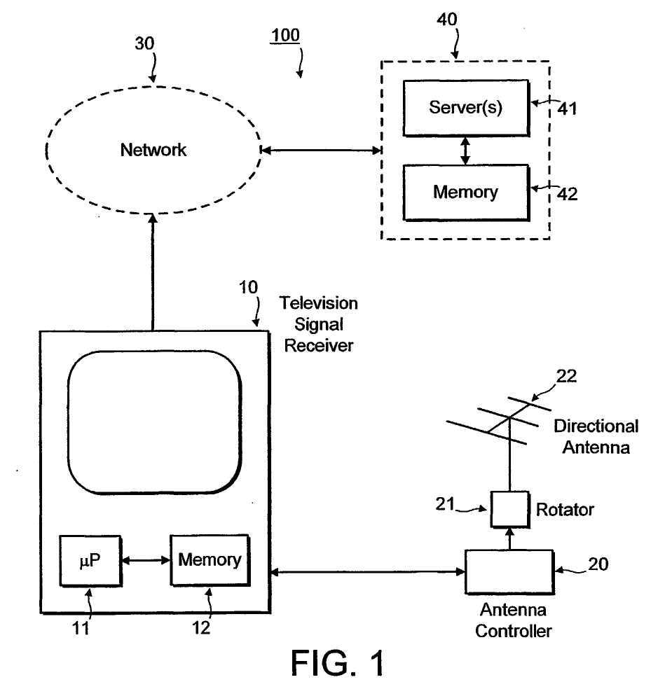

FIG. 1 is a schematic diagram illustrating a system suitable for implementing the present invention; and

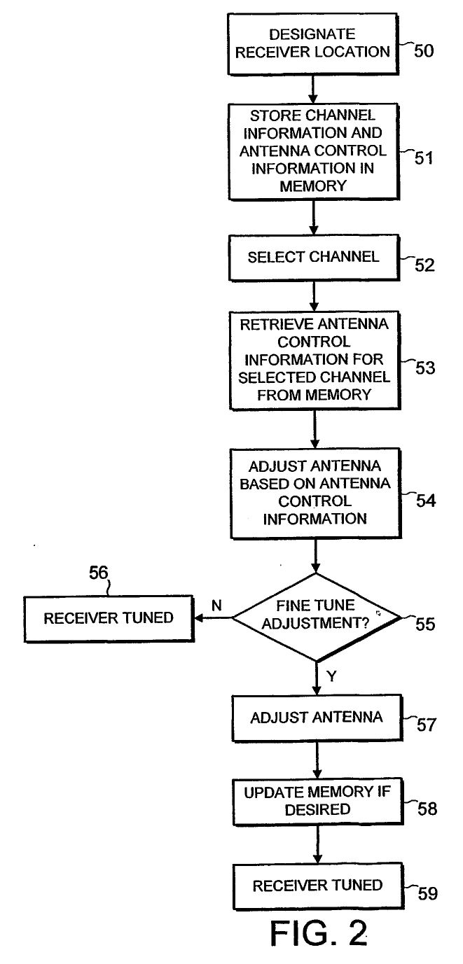

FIG. 2 is a flowchart illustrating exemplary steps for practicing the present invention.

The exemplifications set out herein illustrate preferred embodiments of the invention, and such exemplifications are not to be construed as limiting the scope of the invention in any manner.

Referring now to the drawings, and more particularly to FIG. 1, a schematic diagram of a system suitable for implementing the present invention is shown. In FIG. 1, a system 100 includes a television signal receiver 10 such as a DTV receiver having a microprocessor (μP) 11 and a memory 12. The microprocessor (μP) 11 controls the storage and retrieval of data to and from the memory 12. The television signal receiver 10 is operably coupled to an antenna controller 20 which controls a rotator 21 to adjust the position of a directional antenna 22 associated with the television signal receiver 10. The television signal receiver 10 is also operably coupled to a network 30 such as an intranet or the global communications network known as the internet. A database system 40 is operably coupled to the network 30. The database system 40 includes one or more servers 41 which are operably coupled to a memory 42 to control the storage and retrieval of data to and from the memory 42, and enable transmission of data over the network 30. The memory 42 operates as a storage medium for storing data including channel information and corresponding antenna control information for a plurality of different geographical locations. According to an exemplary embodiment, the channel information includes a list of analog and/or digitally broadcast channels available for terrestrial and/or satellite reception at the plurality of different geographical locations. The antenna control information provides antenna-related data for each of the available channels at the plurality of different locations. That is, the antenna control information may indicate the direction in which an antenna should be pointed for a given channel at a given location. Additionally, the antenna control information may indicate a preferred configuration for an antenna at a given location. The channel information and the antenna control information may also provide data such as the direction of signal transmitters and an approximate signal condition indicator for different channels and antennas at various locations. The channel information and the antenna control information are preferably updated periodically to provide current information. As will be described later herein, the channel information and the corresponding antenna control information are used to assist users in setting up their television systems and achieving good channel tuning.

Referring now to FIG. 2, a flowchart illustrating exemplary steps for practicing the present invention is shown. For purposes of explanation and example, the steps of FIG. 2 will be described in relation to the system 100 of FIG. 1. At step 50, a user provides inputs designating the location of the television signal receiver 10. According to an embodiment, the user may provide a mailing address, telephone number, zip code and/or any other identification information corresponding to the location where the particular television system is intended for use. At step 51, channel information representative of the one or more channels available for reception at the location designated in step 50 and corresponding antenna control information for the channels is stored in the memory 12 of the television signal receiver 10 under the control of microprocessor (μP) 11. Steps 50 and 51 can be performed in a variety of different ways. According to an exemplary embodiment, a user provides inputs to the television signal receiver 10 enabling a communication link between the television signal receiver 10 and the database system 40 via the network 30. Based on the location information provided by the user in step 50, the server 41 accesses the memory 42 and enables the applicable channel information and corresponding antenna control information to be downloaded to the television signal receiver 10 via the network 30. Since the channel information and antenna control information stored in the memory 42 of the database system 40 is preferably updated on a periodic basis, the user can be assured that current information is being provided. Alternatively, steps 50 and 51 can be performed without a network link by loading the memory 12 of the television signal receiver 10 with the channel information and antenna control information directly from a storage medium, such as a CD-ROM, floppy disk or the like, which preferably stores current information. This may require the television signal receiver 10 to include an internal device such as a disk drive, or means for connecting to such a device externally. In essence, steps 50 and 51 represent the process for initially setting up (i.e., programming) the television signal receiver 10 for use. These steps may be performed, for example, at the user's residence or at the place of purchase.

Once the television signal receiver 10 is initially set up for use, the user may select a channel for viewing at step 52. In order to tune the television signal receiver 10 to the selected channel, the memory 12 of the television signal receiver 10 is accessed to retrieve antenna control information corresponding to the selected channel at step 53. Then, at step 54, the television signal receiver 10 causes the antenna controller 20 to control the rotator 21 and adjust the position of the antenna 22 (if necessary) based on the retrieved antenna control information for the selected channel. Next, at step 55, the user is provided an opportunity to perform an additional, fine tune adjustment of the antenna 22. This fine tune adjustment may be performed manually through user inputs to the antenna controller 20, or may be performed by any known algorithm wherein the position of the antenna 22 is fine tune adjusted based on the quality of the received signal. Alternatively, if the user is satisfied with the channel reception after step 54 is performed, he or she may decide not to perform an additional fine tune adjustment of antenna 22 at step 55. In this case, process flow advances to step 56 where the television signal receiver 10 is determined to be properly tuned to the selected channel.

However, should the user decide to perform the fine tune adjustment at step 55, process flow thereafter advances to step 57 where a fine tune adjustment of the antenna 22 is performed. Next, at step 58, the memory 12 of the television signal receiver 10 may be optionally updated (if the user desires) in accordance with the fine tune adjustment. That is, the antenna control information for the selected channel may be updated in the memory 12 of the television signal receiver 10 to reflect the fine tune adjustment. After the fine tune adjustment at step 57 and the optional memory 12 update at step 58, process flow advances to step 59 where the television signal receiver 10 is determined to be properly tuned to the selected channel. In the aforementioned manner, the present invention advantageously provides two stages of antenna control. The first stage occurs at step 54 and is based on the initial set up data stored in the memory 12 of the television signal receiver 10, and the second stage occurs during the fine tune adjustment at step 57. Steps 53 through 59 may be repeated in the aforementioned manner each time a new channel is selected.

As described herein, the present invention provides significant advantages over conventional channel set up and auto-programming techniques. Although the present invention has been described in relation to a television signal receiver, the invention is applicable to various systems capable of receiving off-the-air broadcast signals, either with or without display devices, and the phrases “television signal receiver,” “digital television signal receiver” or “television system” as used herein are intended to encompass various types of apparatuses and systems including, but not limited to, television sets that include a display device, and systems or apparatuses such as a set-top box, video tape recorder (VTR), digital versatile disk (DVD) player, video game box, or personal video recorder (PVR) that may not include display devices.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims. For example, the claimed method and apparatus can be used for FM broadcast radio signal receivers.

1. A method for enabling channel set up in a television signal receiver (10), comprising steps of:
receiving from a storage medium (40) as first input data to said television signal receiver (10), a channel list including one or more channels available for reception by said television signal receiver (10) at a designated location; and
receiving from said storage medium (40) as second input data to said television signal receiver (10), antenna control information corresponding to each of said one or more channels in said channel list.

2. The method of claim 1, further comprising a step of:
storing the channel list and the antenna control information in a memory (12) of said television signal receiver (10).

3. The method of claim 1, further comprising a first step of:
controlling an antenna (22) associated with said television signal receiver (10) in dependence upon said antenna control information.

4. The method of claim 3, further comprising a second step of:
controlling said antenna (22) associated with said television signal receiver (10), said second step of controlling said antenna (22) being performed at a user's option after said first step of controlling said antenna (22).

5. The method of claim 1, wherein:
said storage medium (40) is a database, and said channel list and antenna control information are transmitted from said database to said television signal receiver (10) over an internet (30).

6. The method of claim 5, wherein:
said database (40) is periodically updated to provide current channel information and current antenna control information.

7. The method of claim 1, wherein:
said storage medium (40) is a CD-ROM.

8. The method of claim 1, wherein:
said television signal receiver (10) is a digital television signal receiver.

9. The method of claim 1, wherein:
said one or more channels in said channel list are available for reception by said television signal receiver (10) at said designated location via terrestrial broadcast.

10. A television signal receiver (10), comprising:
memory means (12) for receiving and storing data provided from a storage means (40), said data comprising a channel list including one or more channels available for reception by said television signal receiver (10) at a designated location and antenna control information corresponding to each of said one or more channels in said channel list.

11. The television signal receiver of claim 10, wherein:
said storage means is a database (40), and said channel list and antenna control information are provided from said database to said memory means (12) of said television signal receiver (10) via an internet (30).

12. The television signal receiver of claim 11, wherein:
said database (40) is periodically updated to provide current channel information and current antenna control information.

13. The television signal receiver of claim 10, wherein:
said storage means (40) is a CD-ROM.

14. The television signal receiver of claim 10, wherein:
said television signal receiver (10) is a digital television signal receiver.

15. The television signal receiver of claim 10, wherein:
said one or more channels in said channel list are available for reception by said television signal receiver at said designated location via terrestrial broadcast.

16. A database system (40) for enabling channel set up in a television signal receiver (10), said database system, comprising:
memory means (42) for storing a channel list including one or more channels available for reception by said television signal receiver (10) at a designated location, and antenna control information corresponding to each of said one or more channels in said channel list; and
means (41) for enabling transmission of said channel list and antenna control information to said television signal receiver (10) via a communications network (30).

17. The database system of claim 16, wherein:
said communications network is an internet (30).

18. The database system of claim 16, wherein:
said memory means (42) is periodically updated to provide current channel information and current antenna control information.

19. The database system of claim 16, wherein:
said one or more channels in said channel list are available for reception by said television signal receiver (10) at said designated location via terrestrial broadcast.

20. The database system of claim 16, wherein:
said television signal receiver (10) is a digital television signal receiver.

21. A television signal receiver (10), comprising:
a memory (12) for receiving and storing data provided from a storage medium (40), said data comprising a channel list including one or more channels available for reception by said television signal receiver at a designated location and antenna control information corresponding to each of said one or more channels in said channel list.

22. The television signal receiver of claim 21, wherein said storage medium is a database (40), and said channel list and antenna control information are provided from said database to said memory (12) of said television signal receiver (10) via an internet (30).

23. The television signal receiver of claim 22, wherein said database (40) is periodically updated to provide current channel information and current antenna control information.

24. The television signal receiver of claim 21, wherein said storage medium (40) is a CD-ROM.

25. The television signal receiver of claim 21, wherein said television signal receiver (10) is a digital television receiver.

26. The television signal receiver of claim 21, wherein said one or more channels in said channel list are available for reception by said television signal receiver (10) at said designated location via terrestrial broadcast.

27. A database system for enabling channel set up in a television signal receiver (10), said database system comprising:
a memory (42) for storing a channel list including one or more channels available for reception by said television signal receiver (10) at a designated location, and antenna control information corresponding to each of said one or more channels in said channel list; and
means (41) for enabling transmission of said channel list and antenna control information to said television signal receiver (10) via a communications network (30).

28. The database system of claim 27, wherein said communications network is an internet (30).

29. The database system of claim 27, wherein said memory (42) is periodically updated to provide current channel information and current antenna control information.

30. The database system of claim 27, wherein said one or more channels in said channel list are available for reception by said television signal receiver (10) at said designated location via terrestrial broadcast.

31. The database system of claim 27, wherein said television signal receiver (10) is a digital television receiver.
